(19) United States
(12) Patent Application Publication
(10) Pub. No.: US 2008/0273040 A1
(43) Pub. Date: Nov. 6, 2008

(54) Efficient Selective Updating Of Multiple-Region Flexible Displays

(75) Inventors: Paul Dryer, Marshfield, MA (US); Dale Robertson, Lowell, MA (US); Bryce Xiaobo Xue, Acton, MA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: 3COM CORPORATION, Marlborough, MA (US)

(21) Appl. No.: 11/742,640

(22) Filed: May 1, 2007

(51) Int. Cl. G06F 15/00

(52) U.S. Cl. 345/501

(57) ABSTRACT

Methods and systems are provided for efficiently selectively updating multiple-region flexible displays. In an embodiment, multiple regions of a display material each have a common conductor along a first surface and a patterned set of conductors along a second surface. A control circuit includes a separate conductive trace to each common conductor, such that the control circuit can selectively apply known voltages to the common conductors, as well as a single set of driver lines to all of the patterned sets of conductors, such that any sets of signals sent to any of the patterned sets of conductors are received by all of the patterned sets of conductors. The control circuit is used to selectively apply electric fields between the common conductor and the patterned set of conductors of a subset of the regions, so as to selectively update an appearance of the subset of the regions.

### BACKGROUND

1. Technical Field

The present methods and systems are related to visual displays and, more particularly, to visual displays having multiple regions, for use in devices such as packet-based telephones.

2. Description of Related Art

Since the development of the telephone more than one hundred years ago, the prevalence and importance of telephones has continued to grow. For most of that time, users have used circuit-switched telephones to communicate over circuit-switched networks such as the Public Switched Telephone Network (PSTN). Eventually, Private Branch Exchange (PBX) systems were developed to serve the needs of, for example, businesses with many employees. PBX systems typically include a central entity that connects callers within an office system to each other, and to the PSTN via “outside lines.” And telephones have been developed specifically for PBX implementations. These telephones typically have a display, such as an LCD, as well as some number of buttons designed to correspond to some number of provided features.

Recently, the popularity of the Internet has risen dramatically. Along with the rise of the Internet has come Internet or packet-based telephony, also known as IP (Internet Protocol) telephony, or VoIP (Voice over IP). In packet-based telephony, users' audible inputs are converted to digital data, which is then packetized, or broken into multiple packets, and transmitted using a packet-switched protocol such as IP. Incoming packet data is then arranged in the proper sequence, converted to analog sounds, and output to a user. If one party is using a packet-based telephone and the other party is using a conventional telephone connected to the PSTN, a media gateway may convert between the two types of data transmission.

Increasingly, companies and other institutions are transitioning from PBX to packet-based telephony. Since most of these institutions already have packet-switched networks to manage communications such as e-mail, employing packet-based telephony obviates the need to also have a circuit-switched network for telephone calls and fax messaging. Predictably, packet-based telephones have been developed for use in these systems. Like their PBX counterparts, these packet-based telephones typically have at least a display screen (such as an LCD) and a number of buttons, which may be programmable to provide a number of features.

Among the characteristics of some packet-based telephones are that they often have one or more sets of programmed and/or programmable buttons or other input devices that may be arranged to perform a number of functions. For example, one, two, three, or some other number of these buttons may be associated with separate telephone lines of which the user may take advantage. Note that, in the packet-based-telephony context, these would not typically be actual telephone lines (as they might be in the circuit-switched-telephone environment); rather, they are distinct communication channels that function with respect to the user as multiple lines would.

Furthermore, one or more of these buttons may be associated with a direct-dial function, wherein they would be arranged to dial a particular extension or telephone number. And other functions may be associated with various buttons as well, such as functions associated with checking voicemail, activating a do-not-disturb feature, and/or any other functions.

In connection with these buttons, typical packet-based telephones include an area where a piece of paper may be inserted into a recess and covered by a plastic tab. This paper is typically delineated into regions corresponding to different buttons, with the associated function written, typed, or printed on that region of the paper. Thus, a “1”, “2”, or “3” may be printed on the region of the paper corresponding to lines 1, 2, and 3, respectively. And “DND” may be printed next to the button that corresponds to the do-not-disturb feature. As another example, a person's name may be printed next to a button corresponding to directly dialing that person.

### SUMMARY

Methods and systems are provided for efficiently selectively updating multiple-region flexible displays. In one aspect, an example of an embodiment may take the form of a method. In accordance with the method, a plurality of distinct regions of a display material is provided. Each region has a respective distinct common conductor positioned along a first surface of the region, as well as a respective patterned set of conductors positioned along a second surface of the region, where the second surface is substantially opposite the first surface.

A control circuit is provided, comprising a separate conductive trace connected to each respective common conductor, such that the control circuit can selectively apply known voltages to the common conductors of the various regions. The control circuit further comprises a single set of driver lines connected to all of the patterned sets of conductors, such that any sets of signals sent to any of the patterned sets are received by all of the patterned sets.

The control circuit is used to selectively apply electric fields between the common conductor and the patterned set of conductors of a subset of the regions, so as to selectively update an appearance of the subset of the regions.

These as well as other aspects and advantages will become apparent to those of ordinary skill in the art by reading the following detailed description, with reference where appropriate to the accompanying drawings.

### BRIEF DESCRIPTION OF THE DRAWINGS

Various examples of embodiments are described herein with reference to the following drawings, wherein like numerals denote like entities.

FIG. 1 is a diagram of a communication system, which may be used in accordance with examples of embodiments;

FIG. 2 is a diagram of a packet-based telephone, which may be used in accordance with examples of embodiments;

FIG. 3A is a diagram of a portion of a user interface of a packet-based telephone, in accordance with examples of embodiments;

FIG. 3B is a first partial exploded cross-section of the user-interface portion of FIG. 3A, in accordance with examples of embodiments;

FIG. 3C is a second partial exploded cross-section of the user-interface portion of FIG. 3A, in accordance with examples of embodiments;

FIG. 4A is a diagram of a system, in accordance with examples of embodiments;

FIG. 4B is a diagram of certain aspects of the system of FIG. 4A, in accordance with examples of embodiments;

FIG. 4C is a diagram of certain aspects of the system of FIGS. 4A and 4B, in accordance with examples of embodiments;

FIG. 4D is a diagram of a system, in accordance with examples of embodiments;

FIG. 4E is a diagram of certain aspects of the system of FIG. 4D, in accordance with examples of embodiments;

FIG. 5 is a diagram of a server, in accordance with examples of embodiments; and

FIG. 6 is a flowchart of a method, in accordance with examples of embodiments.

### DETAILED DESCRIPTION OF THE DRAWINGS

### 1. Overview

The present methods and systems provide efficient selective updating of multi-region flexible displays and, as one application, may be employed in the context of an enterprise that maintains multiple packet-based telephones connected over a network. Each telephone may have a user interface that includes one or more elements such as those described above, or perhaps variants thereof. In particular, each telephone may have a plurality of buttons that are programmed to provide different functions, such as access to different lines of communication, a do-not-disturb function, one or more speed/direct dials, and/or any other function(s).

Associated with that plurality of buttons may be a multi-region display that has a region corresponding to each button. In examples of embodiments, these regions may each include a section of a flexible display material such as that manufactured by SiPix Imaging, Inc. of Fremont, Calif. This material, known as “e-Paper,” may be made up of numerous modules referred to by SiPix and herein as “microcups.” Each microcup is essentially a small capsule containing both (1) a relatively viscous liquid of a given color and (2) an object, which may be referred to herein as a “particle,” “ball,” or perhaps a “puck.” In this example, the particle is white and the viscous liquid is black, though these color choices are for illustration and not by way of limitation. Any colors could be used for either.

The appearance of each microcup is controlled by application of an electric field between two of its opposing surfaces. That is, by applying different voltages between the two opposing surfaces, the particle inside the microcup can be electrically influenced to move (i) as close as possible to a viewer's vantage point, in which case the microcup would appear white (i.e. the color of the particle), (ii) as far as possible from the viewer's vantage point, in which case the microcup would appear black (i.e. the color of the viscous liquid), or (iii) somewhere in between those two extremes, in which case the microcup would appear some shade of gray between white and black, depending on the particular position of the particle in the viscous liquid.

A typical use of a section of e-Paper may involve positioning what is referred to herein as a “common conductor” along a first surface of the section's microcups, and what is referred to herein as a “patterned set of conductors” along a second surface of the section's microcups. Note that the section of e-Paper in question could be made up of an array of rows and columns of microcups juxtaposed against one another, where each microcup has a top surface and a bottom surface. Thus, taken together, the top surfaces of the microcups would form one surface, against which the common conductor may be positioned, while the bottom surfaces of the microcups would form a second surface, against which the patterned set of conductors may be positioned.

As examples, the common conductor could be a transparent piece of plastic coated with a conductive material, while the patterned set of conductors could be an arrangement of individual metal conductors that are each connected to a driver line from an integrated circuit (IC). One current implementation, often referred to as segment displays, involves a patterned set of conductors that includes several groups of seven individual conductors in each group, such that each group could be used to display, a numeral on a digital clock. In this implementation, each individual conductor in each group would be connected to its own driver line from the IC, such that a typical four-digit clock would require twenty-eight driver lines to the patterned set of conductors. In operation, then, selective activation of the IC driver lines would cause different numerals to be displayed to a viewer through the common conductor.

While this may prove workable in the context of simple displays such as digital clocks, this simply is not scalable to updating a display such as that described above for packet-based telephones, where, for example, on the order of ten buttons need labels, where each one may have ten characters, and where each character may correspond to a 7-row, 5-column array of individual conductors (in order to be able to display the assortment of alphanumeric characters found in names and phone numbers). It just is not feasible on a typical packet-based telephone to wire, power, and control on the order of 3500 IC-driver lines to write different alphanumeric sequences to the ten different button labels. This would be too expensive to build, and too great a burden on processing power and time for a typical packet-based telephone, especially one powered by power over Ethernet (PoE).

However, e-Paper does have a number of attractive qualities for the PoE-powered, packet-based telephone context. For one, the microcup displays are bi-stable, which means that it does not take much power to change their appearance state, and they hold that state without power being constantly applied. Moreover, the microcups provide excellent contrast for viewing purposes, akin to that of printed text on actual paper. Furthermore, the message or image displayed on e-Paper is easily and attractively viewable from a number of different angles.

Additionally, e-Paper can be cut along microcup boundaries into a number of different shapes, which opens up numerous possibilities for custom-fitting a display to numerous applications. Moreover, the e-Paper material is flexible, which makes it suitable to the contoured shape of many modern devices, including the generally convex shape of many packet-based telephones. Also, e-Paper is capable of resolution in the 300 dpi (dots per inch) range. And e-Paper has other benefits as well, as this list is not meant to be exhaustive.

In accordance with the present methods and systems, a control circuit is provided for efficiently selectively updating a multi-region display. Consider the example described herein of the plurality of buttons on a packet-based telephone, where each button has an associated label. Each of those regions includes, for example, a generally rectangular (perhaps square) piece of e-Paper. Each region further has a respective transparent common conductor positioned between the viewer's vantage point and the e-Paper. Each common conductor is connected by its own conductive trace to the control circuit, such that the control circuit can selectively apply a known voltage to one, some, or all of the common conductors. And the common conductors are separated from one another by enough distance and/or material such that a voltage applied to one common conductor will be applied to that common conductor only, and will not bleed over to any of the other common conductors.

Furthermore, in this example, underneath the e-Paper, each region has a patterned set of conductors made up of ten 7-row, 5-column grids of individual conductors, where each such grid corresponds to a character that the control circuit can write. Unlike the common conductors, however, the patterned sets of conductors of all of the regions are connected to the same output (i.e. to a single set of driver lines) from the control circuit. That is, while the control circuit can selectively send signals to some individual conductors and not others in each region, so as to write different characters, all of the regions in the multi-region display receive the same sets of signals on their respective patterned sets of conductors. That is, any set of signals that is sent to one region's patterned set of conductors is sent to all of the regions' patterned sets.

In operation, when the control circuit wants to update a particular label (i.e. region) to display a particular pattern (i.e. set of characters), the control circuit writes that pattern to the patterned sets of conductors of all of the regions, and then only activates (i.e. sets to a known voltage (such as ground)) the common conductor for the particular region to which the control circuit wants to write. And similarly, if the control circuit wants to write the same text to two or more regions, the control circuit would activate the common conductors for those regions only. For the other regions (not being updated), the control circuit may just let their common conductors “float,“in other words lets them have whatever voltage they would have without any control being exerted by the control circuit. Their appearance would thus remain unaffected, due to the bi-stability of e-Paper and the absence of an applied electric field across the microcups of those regions. When the control circuit is not writing to any regions (not updating any labels, i.e. most of the time), the control circuit similarly lets all the common conductors float, and lets the bi-stability of the e-Paper maintain each label's appearance (e.g. displayed text).

Thus, among other advantages of the present methods and systems, the number of IC output lines (driver lines to patterned sets of conductors, as well as conductive traces to common conductors) necessary to update a multi-region display is greatly reduced. In the above example, where there are ten regions, each having ten 7-row, 5-column characters, a prior implementation would require on the order of 3501 output lines, where 3500 of them would serve as drivers for the pixels (i.e. microcups or adjoining groups of microcups) of all of those characters, and one would serve as a conductive trace to a unitary common conductor across all of the labels. In contrast, in accordance with the present methods and systems, this number is reduced to around 360, where 350 would be drivers connected to all ten regions (i.e. button labels), and 10 would be used as conductive traces to the now-separate-and-distinct common conductors, where each respective common conductor overlays a respective region of the multi-region display.

Note that, in some embodiments, as described above, each region (i.e. each common conductor) may cover one label for one particular button; in other embodiments, however, each region (i.e. each common conductor) may cover only a single character; and other possibilities exist as well, without departing from the scope and spirit of the present systems and methods. Returning to the one-common-conductor-per-button-label example, this reduction in IC-output lines has the added benefit of making a flexible substrate, such as a material known as “flex tab,” a feasible option for the common conductor. If the IC-output-line count were not so reduced, a non-flexible etched glass substrate would be necessary, which would come at a higher cost, in addition to the loss of flexibility. Note that, in examples of embodiments, the control circuit may include a microprocessor that controls more than one IC. As an example, one, two, or more than two ICs such as the DenMOS DSM04001 162-Output Passive-Matrix Electro Phoretic Display (PM-EPD) Driver may be used.

With respect to using flex tab as the substrate for the common conductors, multiple approaches could be used. One would be to silkscreen a conductive liquid on to the flex tab, where each respective common conductor for each respective region of the display would be masked off. Another approach would be to cut pieces of the e-Paper and affix them, such as by lamination for instance, to a piece of the flex tab material, which is essentially a flexible piece of plastic. Yet another approach would be to etch copper on the flex tab to make the various regions' common conductors. And note that, in some embodiments, common conductors for neighboring regions could be separated by a distance that is only as wide as a single row of microcups, though other separation distances could be used as well.

And other variations exist in accordance with the present methods and systems. For example, instead of each corresponding pixel (i.e. individual conductor aligned with a microcup or adjoining group of microcups) on each region being tied to its own driver, these corresponding pixels could instead be column-and-row addressable by a suitable microprocessor and/or one or more ICs. That is, a grid of conductor lines may underlie a given region, and the control circuit could activate the column and row of the pixel to be written, such that only the intended pixel would be written (while also activating the proper common conductor).

Moreover, some embodiments may involve reversing the ordering of the patterned sets of conductors, microcups, and common conductors with respect to the viewer's vantage point. That is, the patterned sets of conductors may be made up of transparent individual conductors that are constructed in the manner described above with respect to the transparent common conductors. As such, the viewer may look through the patterned-conductor side, and the common-conductor side may be behind/underneath the microcups, from the viewer's vantage point.

In other embodiments, the multi-region display may be viewable from both sides, such as when the display is free-standing, perhaps vertically-oriented. In that case, both the patterned sets of conductors and the common conductors may be transparent, such that viewers may view the multi-region display through the patterned sets of conductors from one side and through the common conductors from the other side, which may result in the appearance of the display from one side being somewhat like a photo negative of the appearance of the display from the other side. And other possibilities exist as well.

There are of course additional aspects of the present methods and systems. As such, this overview is for illustration and not by way of limitation.

### 2. Example Architecture

a. Example Communication System

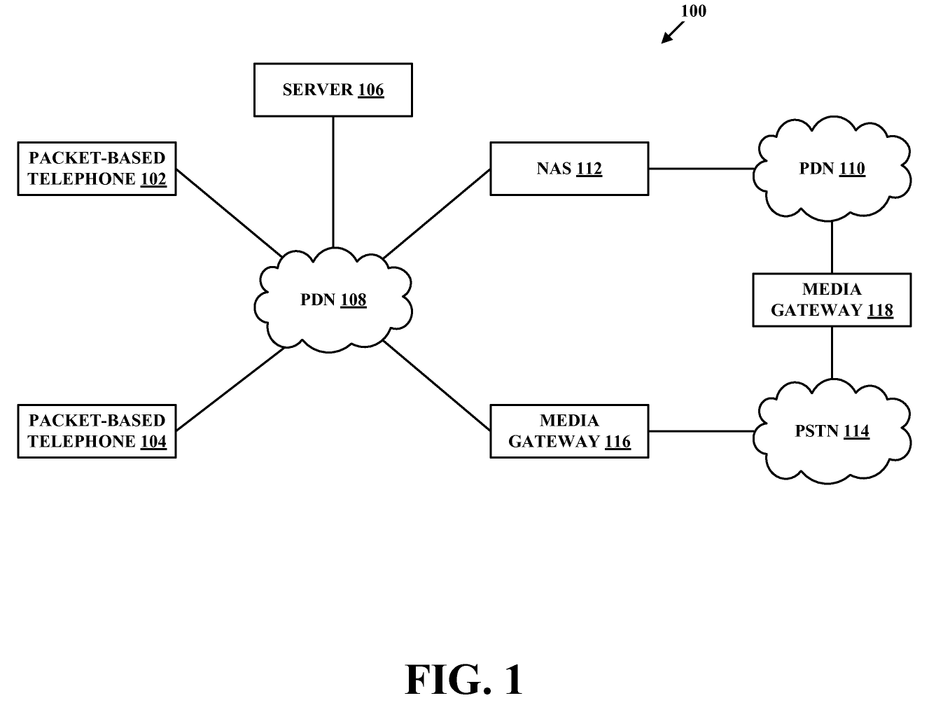

FIG. 1 is a simplified block diagram of an example of a communication system that may be used in accordance with examples of embodiments. It should be understood that this and other arrangements described herein are set forth only as examples. Those skilled in the art will appreciate that other arrangements and elements (e.g., machines, interfaces, functions, orders, and groupings of functions, etc.) can be used instead, and that some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. Various functions may be carried out by a processor executing instructions stored in memory.

As shown in FIG. 1, the communication system 100 includes packet-based telephones 102 and 104, a server 106, packet-data networks (PDN) 108 and 110, a network access server (NAS) 112, a public switched telephone network (PSTN) 114, and media gateways 116 and 118. It should be understood that any number of additional network entities could be present as well. As examples, there could be any number of packet-based telephones and other devices in communication with the PDN 108. Furthermore, there could be any number of intermediate devices and networks making up all or part of any of the communication links. For example, there could be one or more routers on the link between the NAS 112 and the PDN 110.

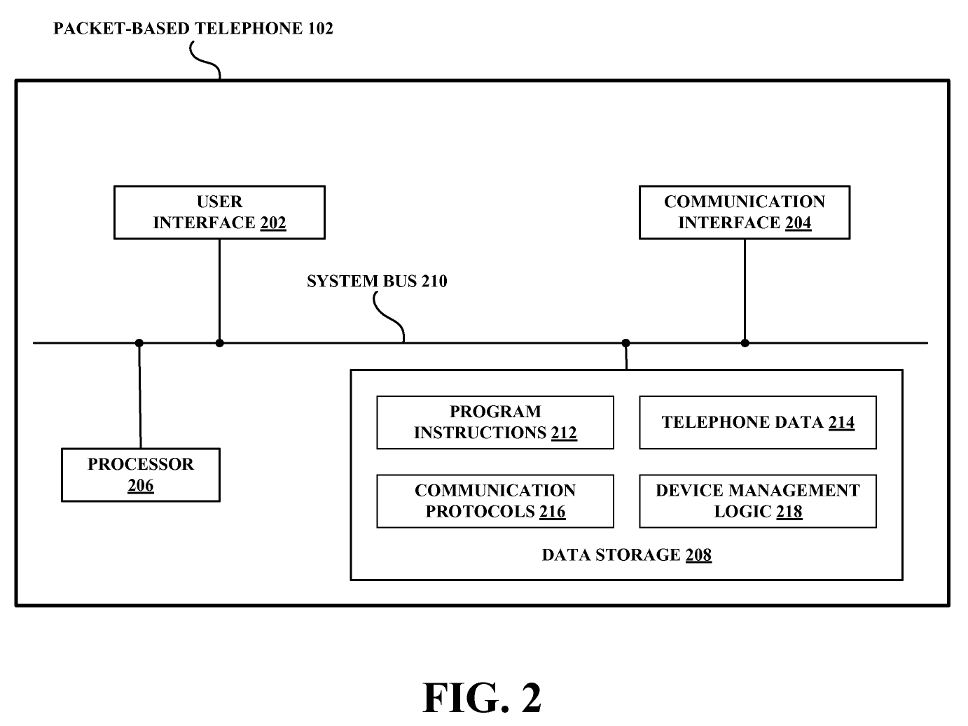

The packet-based telephones 102 and 104 may be any packet-based telephony devices programmed to carry out the packet-based-telephone functions described herein. As such, the packet-based telephones 102 and 104 may each include a user interface, a communication interface, a processor, and data storage. The packet-based telephones 102 and 104 may be communicatively coupled with at least the PDN 108, and may be capable of communicating with the PDN 108 in a wired and/or wireless manner. Packet-based telephone 102 is further described in connection with FIGS. 2, 3A through 3C, and 4A through 4E.

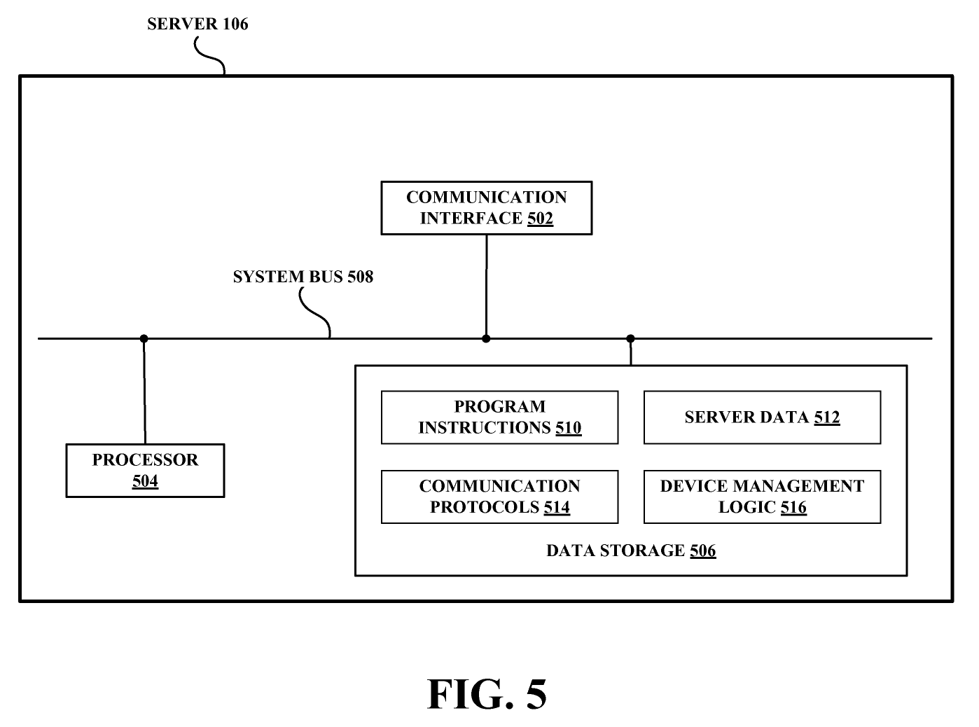

The server 106 may be any networking device programmed to carry out the server functions described herein. As such, the server may include a communication interface, a processor, and data storage. The server 106 may be communicatively coupled with at least the PDN 108, and may be capable of communicating with the PDN 108 in a wired and/or wireless manner. The server 106 is further described in connection with FIG. 5.

The PDN 108 may be communicatively coupled with at least the packet-based telephones 102 and 104, the server 106, the NAS 112, and the media gateway 116, and may include one or more wide area networks, one or more local area networks, one or more public networks, one or more private networks, and/or one or more wired or wireless networks. Devices in communication with the PDN 108 may exchange data using a packet-switched protocol such as IP, and may be identified by an address such as an IP address.

The PDN 110 may be communicatively coupled with at least the NAS 112 and the media gateway 118, as well as likely numerous other devices, and may include one or more wide area networks, one or more local area networks, one or more public networks such as the Internet, one or more private networks, and/or one or more wired or wireless networks. Devices in communication with the PDN 110 may exchange data using a packet-switched protocol such as IP, and may be identified by an address such as an IP address.

Note that FIG. 1 depicts the PDN 108 as a privately-operated IP network (such as an enterprise's corporate network) and the PDN 110 as a public IP network (such as or including the Internet). This arrangement is merely illustrative, as there is no reason that the packet-based telephones 102 and 104, server 106, and any other device shown herein could not communicate with each other and with other entities at least in part over a single packet-data network such as or including the Internet. And other arrangements are possible as well.

The PSTN 114 may be the circuit-switched network known as the Public Switched Telephone Network, and may be communicatively coupled with at least the media gateway 116 and the media gateway 118, as well as with numerous other switches and telephony devices.

The NAS 112 may be any networking device programmed to interface between the PDN 108 and the PDN 110. As such, the NAS 112 may include a processor, data storage, and at least one communication interface. The NAS 112 may be programmed to communicate in a wired and/or wireless manner with the PDN 108 and/or the PDN 110. The NAS 112 may act as a network access server with respect to the PDN 108, and could include a router.

The media gateways 116 and 118 may be devices programmed to interface between a PDN and the PSTN 114, and may thus have a processor, data storage, an interface for communicating with a PDN, and another interface for communicating with the PSTN 114. The media gateways may thus receive packet-based communications from a PDN, convert those communications to a circuit-switched format, and transmit those communications to the PSTN. The media gateways may also receive circuit-switched communications from the PSTN, convert those communications to a packet-based format, and transmit those communications to a PDN.

b. Example Packet-Based Telephone

i. Generally

FIG. 2 is a simplified block diagram of an example of a packet-based telephone that may be used in accordance with examples of embodiments. Note however, that the present systems and methods could be used with respect to other types of telephones and other types of devices generally, and that packet-based telephones are described by way of example. As shown in FIG. 2, packet-based telephone 102 includes a user interface 202, a communication interface 204, a processor 206, and data storage 208, all of which may be communicatively linked by a system bus 210. Packet-based telephone 102 may be any device programmed to communicate over the PDN 108, and to carry out the packet-based-telephone functions described herein. Furthermore, it should be understood that the packet-based telephone 104 may have a structure similar to that described with respect to the packet-based telephone 102.

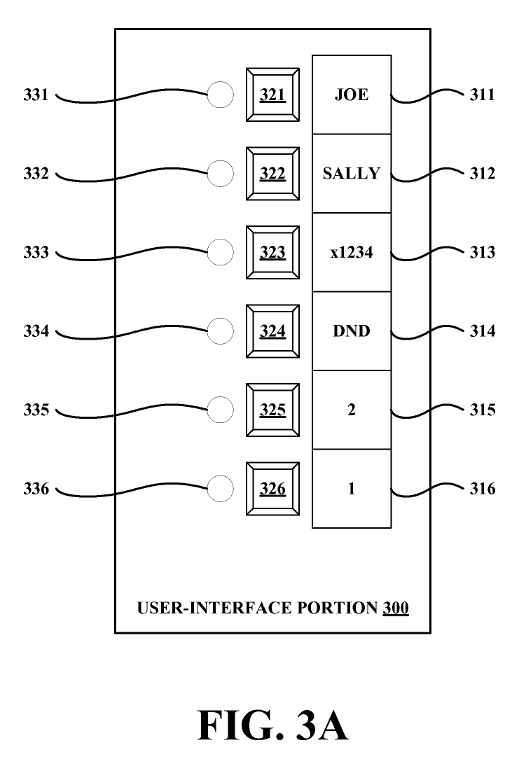

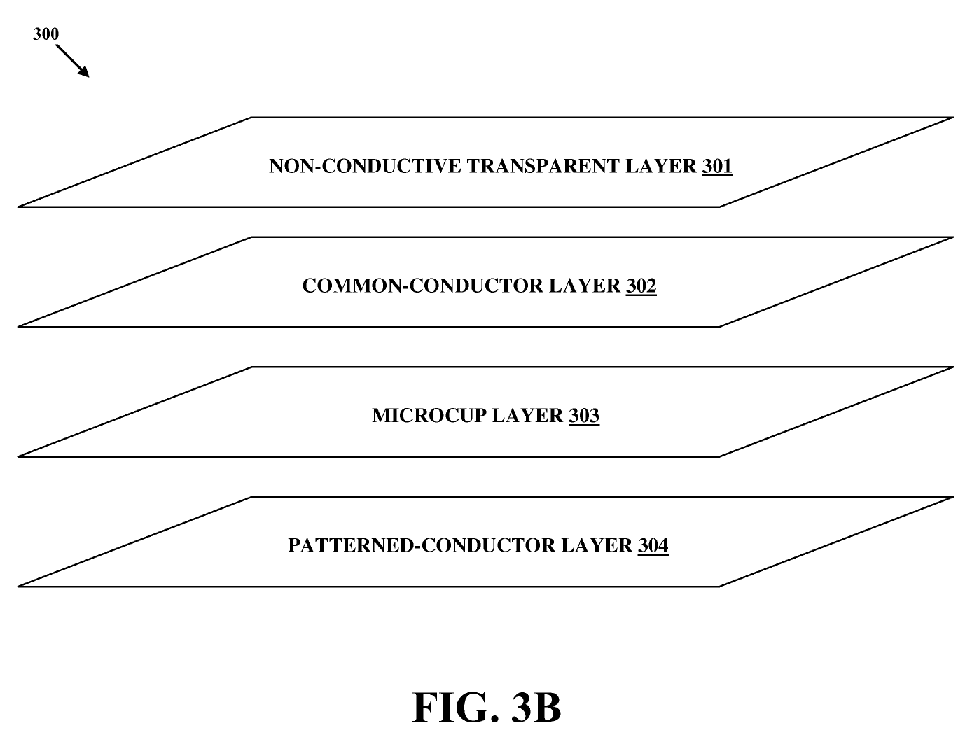

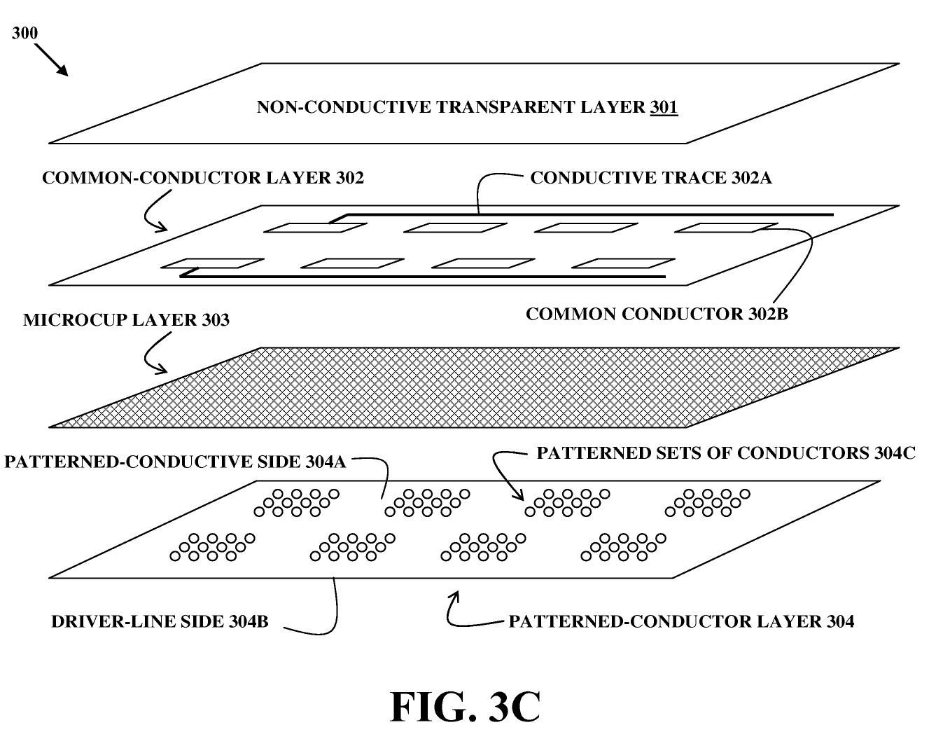

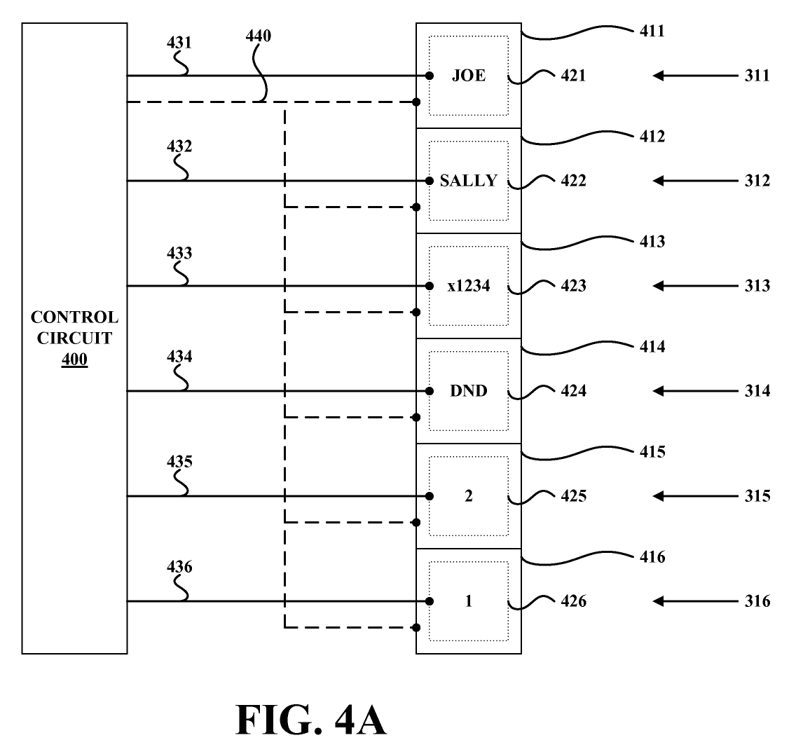

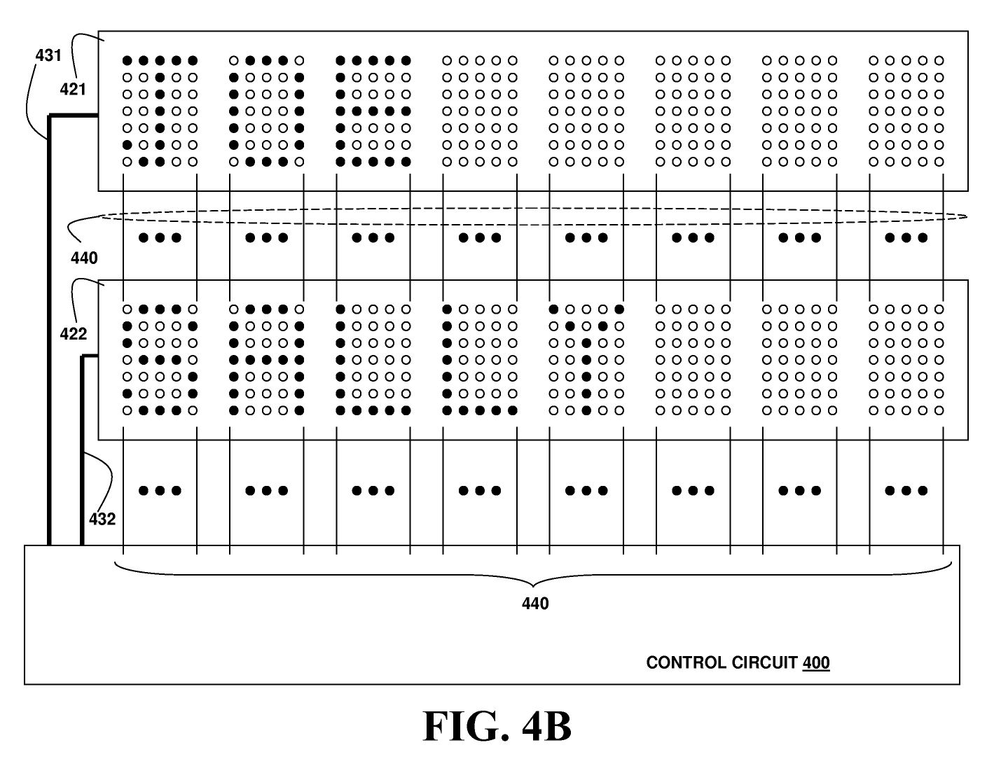

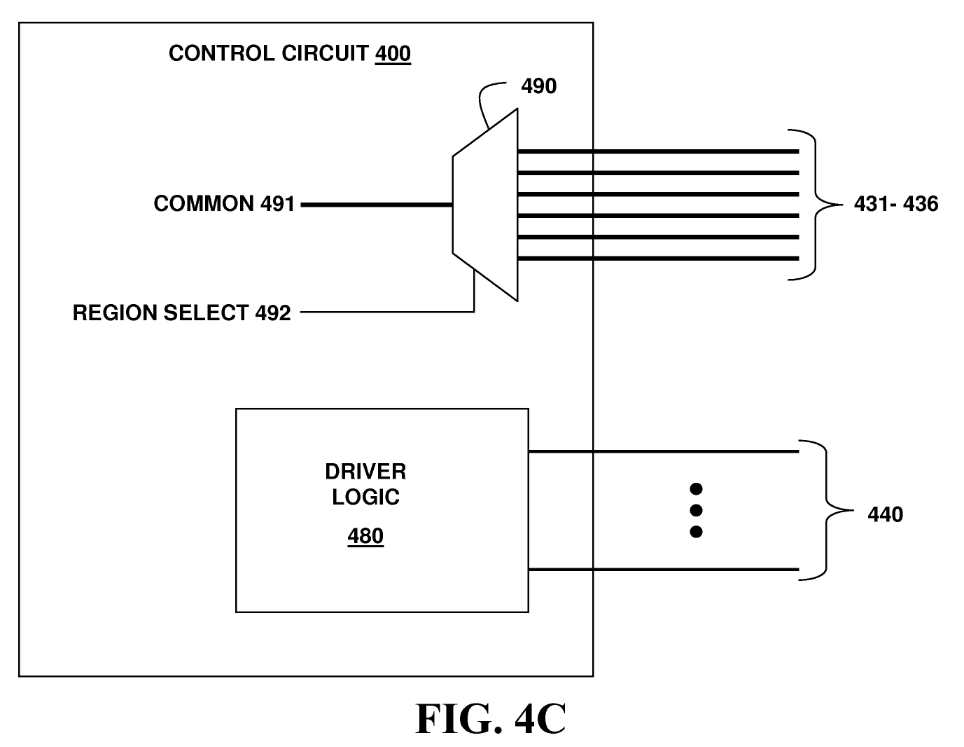

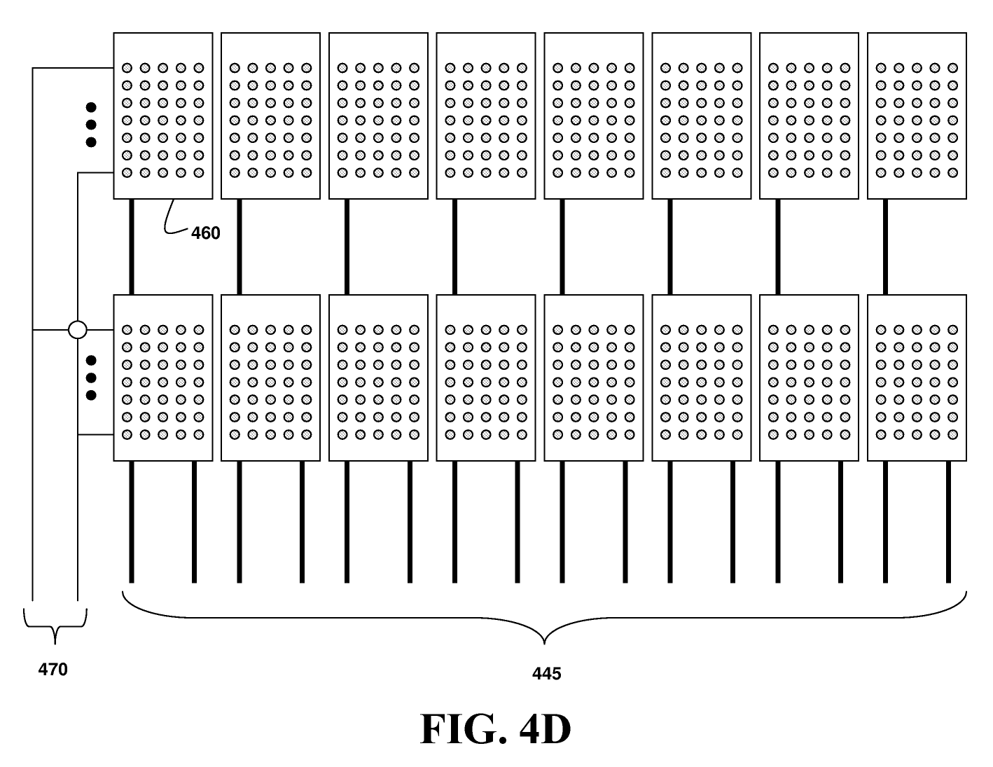

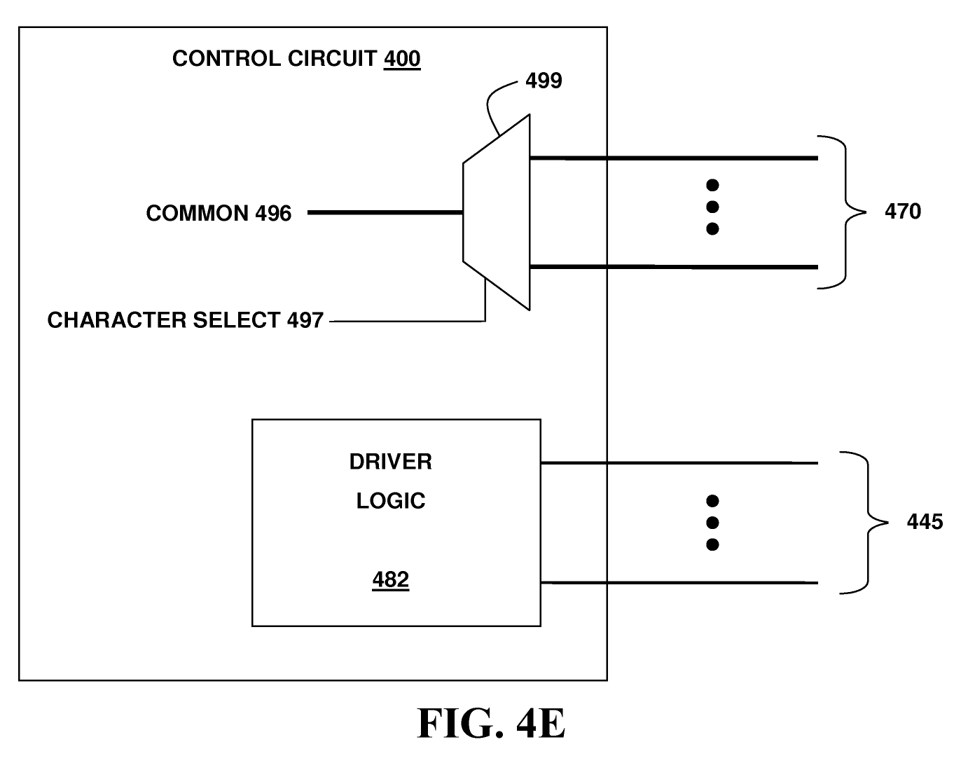

The user interface 202 may include one or more devices to receive user inputs, as well as one or more devices to convey outputs to users. For receiving inputs, the user interface 202 may include a microphone, one or more buttons, and/or any other device now known or later developed to receive user inputs. For conveying outputs, the user interface 202 may include a speaker, a display such as a liquid crystal display (LCD), an e-Paper display, one or more lights and/or light emitting diodes (LEDs) for indicating one or more states, and/or any other device now known or later developed to convey outputs to users. Note that user interface 202 is further discussed below in connection with FIGS. 3A through 3C and 4A through 4E.

The communication interface 204 may be used by the packet-based telephone 102 to engage in packet-switched communication over the PDN 108 with one or more devices such as the packet-based telephone 104, one or more other packet-based telephones, the server 106, and one or more other devices via the NAS 112 and/or the media gateway 116. As stated, the packet-based telephone may be capable of communicating over the PDN 108 in a wired and/or wireless manner. As such, the communication interface 204 may include an Ethernet card, and may also or instead include a chipset and antenna for wireless communication. In some embodiments, the packet-based telephone 102 may use communication interface 204 to download configuration data from some other network entity, such as the server 106; this configuration data may include, among other things, text and/or other display patterns to be written to various labels associated with various buttons, in accordance with the present methods and systems.

The processor 206 may comprise multiple (e.g., parallel) processors, such as a general purpose microprocessor and/or a discrete digital signal processor. The data storage 208 may take various forms, in one or more parts, such as a non-volatile storage block and/or a removable storage medium. Note that the processor 206-block in FIG. 2 may encompass devices such as the control circuit, microprocessor(s), and integrated circuits (ICs) discussed herein, including those discussed below with respect to FIGS. 4A through 4E.

The data storage 208 may store program instructions 212, telephone data 214, communication protocols 216, and device management logic 218. The program instructions 212 may be executable by the processor 206 to carry out various functions described herein. The telephone data 214 may include any types of data useful for operation of telephone 102. Communication protocols 216 may be useful to receive data from and send data to one or more network entities, and may include any protocols suited to carrying out the functions described herein, including any proprietary protocols and/or any other protocols. Compatible protocols may be stored in entities in communication with the packet-based telephone 102. The device management logic 218 may be used to manage aspects such as memory and file management.

ii. User Interface and Control Circuit

FIG. 3A depicts a portion 300 of user interface 202. In particular, user-interface portion 300 includes six labels 311-316. Each label may be considered to be a region of a multi-region display. As such, each of the labels 311-316 may include a flexible display material such as e-Paper, as well as a respective common conductor positioned along a top surface of each region, which would be the surface in between the e-Paper and the viewer of the region (i.e. the surface that a user would see when looking at telephone 102). And each region 311-316 further includes a respective patterned set of conductors positioned along a bottom surface of the region, which would be the surface of the e-Paper that is hidden from normal view. This patterned set of conductors may take the form of ten side-by-side, 7×5 grids of individual conductors, suitable for creating various alphanumeric characters, or perhaps some other form.

Further depicted in FIG. 3A is the fact that each region 311-316 is associated with an input mechanism, in this case a button 321-326. As can be appreciated from FIG. 3A, in this example, the label 311 and button 321 are associated with a speed dial to a person named “Joe,” while the label 312 and button 322 are associated with a speed dial to a person named “Sally,” and the label 313 and button 323 are associated with a speed dial to an extension “x1234.” Furthermore, the label 314 (“DND”) and the button 324 are associated with a do-not-disturb function. And the label 315 and button 325 are associated with a “line 2” available to the user, while the label 316 and button 326 are associated with a “line 1” available to the user. Note that other functions could be associated with a given button and a suitable label used for that function, including a function to check voicemail, among other possibilities. Note further that, in some embodiments, the display regions themselves may be buttons.

Each label-and-button combination is also associated with a light-emitting diode (LED) 331-336 (or other suitable indicator) in this example. These lights could be used to indicate if one of the user's speed dials is currently on the phone (or have their DND feature activated), or to indicate that the user's DND feature is activated, or that a line generally available to the user is in use or otherwise unavailable. And while six label-button-LED combinations are illustrated in FIG. 3 by way of example, any other number of such combinations could be used, including any number of available lines, speed dials, other functions, etc.

Reference is now made to FIGS. 3B and 3C, which are exploded cross-section views of the user-interface portion 300 of FIG. 3A. The reader can readily appreciate that, as shown in FIG. 3B, the user-interface portion 300 includes a non-conductive transparent layer 301, a common-conductor layer 302, a microcup layer 303, and a patterned-conductor layer 304. And, for orientation, the user's typical vantage point—and the viewer vantage point used in the present example—would be to look from the top of FIG. 3B. That is, layer 301 would be the closest to the viewer, while layer 304 would be furthest away, though other possibilities exist, such as a non-conductive transparent layer being positioned below layer 304 in FIG. 3B, instead of or in addition to layer 301, and the viewer vantage point being from the bottom of FIG. 3B, or both the bottom and the top, as described herein.

These layers are now described, with reference to FIG. 3C, in reverse numerical order. Note that FIG. 3C depicts the same four layers that are depicted in FIG. 3B, along with some additional detail. First, the bottom—a.k.a. patterned-conductor—layer 304 includes the above-described patterned sets of conductors 304C, where each such patterned set of conductors corresponds to a different region of the display 300, and where each patterned set of conductors includes multiple individual conductors arranged in a particular pattern. Each such individual conductor—and thus each patterned set—is aligned with one or more microcups of layer 303.

Furthermore, layer 304 has (1) an upper surface that is labeled the patterned-conductive side 304A and (2) a lower surface that is labeled the driver-line side 304B. All of the patterned sets of conductors 304C are connected to a single set of driver lines that may be run on side 304B and connected through apertures in layer 304 to the patterned sets of conductors 304C on side 304A. If the driver lines are run on the same side (304A) of layer 304 as the patterned sets of conductors, care should be taken to avoid having a common conductor aligned directly above the driver lines on the other side of the microcup layer 303, in the common-conductor layer 302.

Above the patterned-conductor layer 304 is the microcup layer 303, which contains the liquid and particles sealed in small individual microcups, described herein. Above layer 303 is the common-conductor layer 302, which contains transparent conductive common pieces (i.e. the respective common conductors 302B for the respective regions of multi-region display 300, each corresponding to and aligned with a patterned set of conductors 304C in layer 304).

Each common conductor 302B may have a respective transparent conductive trace 302A connecting that common conductor to the control circuitry. Note that only two such conductive traces are depicted in FIG. 3C, though each common conductor 302B would preferably have a trace. Note that the size, shape, and position of the common conductors 302B control the areas that will be updated when the drivers present a charge different from the common conductors.

Finally, the non-conductive transparent layer 301 is applied on top, to maintain the position of the traces 302A and common conductors 302B of the common-conductor layer 302, protect the other layers, and provide any necessary anti-glare function, among other purposes.

Turning to FIG. 4A, an example of a circuit is depicted; in particular, FIG. 4A depicts a control circuit 400 electrically connected with regions 311-316 of user-interface portion 300 of FIGS. 3A through 3C. In FIG. 4A, region 311 (“Joe”) has a transparent common conductor 421 (such as 302B in FIG. 3C) overlaying a section of e-Paper (in layer 303 in FIG. 3C) that contains a number of microcups. The region 311 also includes an underlying patterned set of conductors 411 (such as 304C in FIG. 3C), which has an array of individual conductors (not individually depicted in FIG. 4A) arranged such that each individual conductor of the patterned set of conductors 411 is associated with one or more microcups of the region 311.

Note that the common conductors 422-426 similarly overlay the regions 312-316, and that common conductors 421-426 are not in electrical contact with each other. Moreover, the patterned sets of conductors 412-416 similarly underlay the regions 312-316.

Control circuit 400 has a separate conductive trace (such as 302A in FIG. 3C) 431-436 connected to each common conductor 421-426, such that control circuit 400 can selectively set one or more of those common conductors 421-426 for their respective display regions to a known voltage (and preferably to ground), while writing to all of the regions' patterned sets of conductors, to thereby selectively update one or more of regions 311-316.

To do such writing, a single set of driver lines 440 is connected to all of the patterned sets of conductors 411-416. The set of driver lines 440 preferably includes the same number of driver lines as the number of individual conductors in each patterned set. So, if each patterned set has ten 7×5 grids of individual conductors, for a total of 350 individual conductors per patterned set, then the set of driver lines 440 would have 350 driver lines. And each of those 350 driver lines would be connected to a respective corresponding set of individual conductors across all of the patterned sets. So, for example, driver line 1 may be connected to the upper-left-most individual conductor in all of the patterned sets 411-416, driver line 5 would be connected to the upper-right-most individual conductor in all of the patterned sets, and so on.

As stated, control circuit 400 has a separate conductive trace 431-436 connected to each common conductor 421-426, such that control circuit 400 can selectively apply known voltages to the common conductors 421-426 of the various regions 311-316. And control circuit 400 also has a single set of driver lines 440 connected in to all of the patterned sets of conductors 411-416, such that any sets of signals sent by control circuit 400 to any of the patterned sets of conductors 411-416 are received by all of the patterned sets of conductors 411-416. With this arrangement, control circuit 400 can selectively apply electric fields between the common conductor and the patterned set of conductors of one or more of the regions, so as to selectively update the appearance of that subset of regions, in particular by applying various voltages across selected microcups in the selected region(s) 311-316. In typical operation, control circuit 400 will write to one such region 311-316 at a time. FIG. 4B shows further detail as to some aspects of FIG. 4A. In particular, FIG. 4B depicts common conductor 421 and conductive trace 431 of region 311, as well as common conductor 422 and conductive trace 432 of region 312. FIG. 4B further depicts the single set of driver lines 440 and control circuit 400. In this example, each of the patterned sets of conductors have eight side-by-side, 7×5 grids of small circular individual conductors, one grid per writable character. Note that each of those individual circular conductors may be aligned with one microcup, or perhaps with a group of adjoining microcups. It can be seen that “Joe” is written in the upper region 311, and that “Sally” is written in the lower region 316, in accordance with FIG. 4A. It can be appreciated from FIG. 4B that each character in the same column—for example, the “J” in “Joe” and the “S” in “Sally”—share the same driver lines among the single set of driver lines 440.

FIG. 4C shows further detail as to some aspects of FIGS. 4A and 4B. In particular, FIG. 4C shows that control circuit 400 may comprise a common line 491 and a region-select line 492, both connected to a multiplexer 490, which in turn is connected to the conductive traces 431-436 to each respective common conductor 421-426 of regions 311-316. Also, control circuit 400 includes driver logic 480 connected to the single set of driver lines 440, which connect—and send the same sets of signals—to all of the patterned sets of conductors 411-416.

In operation, region-select line 492 controls to which conductive trace 431-436 the multiplexer 490 connects common line 491. Furthermore, driver logic 480 determines the textual output to be sent to all of the regions 311-316 via the set of driver lines 440, and written to the region(s) selected by the region-select line 492, in cooperation with the multiplexer 490. Thus, it can be readily appreciated that, in this configuration, at most one display region common conductor 421-426 is connected to ground, while the other display regions are left floating. That is, the regions of the multi-region display would be writable one at a time.

FIG. 4D shows an alternative embodiment in which the number of driver lines needed (to provide each label the same number of characters) is reduced by isolating the common conductors down to one per character. The separate common conductors 460 are connected to conductive traces 470, which may be made from transparent material. The common conductors and associated traces may be held in position by adhering to a transparent non-conductive top layer, as described. Similar to the example of FIG. 4B, the patterned sets of conductors corresponding to the single-character regions are driven by a single set of driver lines 445 from a control circuit such as control circuit 400. Again, the same sets of signals will be sent to all of the patterned sets of conductors, and only those region(s) to which the control circuit decides to write will have their common conductor(s) 460 set to a known voltage such as ground by using conductive trace(s) 470.

As shown in FIG. 4E, all of the common conductive traces 470 may be connected to a multiplexer 499, which may in turn be connected to a common line 496 and a character-select line 497. These components may operate analogously to corresponding components described above with respect to FIG. 4B. It can be appreciated that only 35 patterned-conductor driver lines 445 are needed in this example, since all of the character regions are connected in parallel to a 35-bit-wide bus. Since each character region's common conductor 460 has been isolated, the subset of character regions that are updated by the drivers 445 is determined by which common conductor 460 the multiplexer 499 selects to connect to common line 496.

Thus, in FIGS. 4B and 4C, each common conductor spans a row of characters while, in FIGS. 4D and 4E, each common conductor spans a single character. It is an aspect of the present methods and systems that the implementer can balance the number of IC output lines (i.e. conductive traces to common conductors and driver lines to patterned sets of conductors) against the number of common conductors, to select the most cost-effective, technologically-attractive, and otherwise advantageous solution for the display application at hand.

c. Example Telephony Server

FIG. 5 is a simplified block diagram of an example of a server that may be used in accordance with examples of embodiments. In particular, FIG. 5 illustrates that the server 106 of FIG. 1 includes a communication interface 502, a processor 504, and data storage 506, all of which may be communicatively linked by a system bus 508. In general, the server 106 may be any networking device arranged to communicate over one or more networks, and to carry out the server functions described herein. As one example function, server 106 may store configuration data, such as text to be written to various display regions, for given telephones.

The communication interface 502 may be a combination of hardware and software used by server 106 to communicate with the packet-based telephones 102 and 104, as well as possibly one or more additional entities, and may, for example, include an Ethernet card. The communication interface 502 may, instead or in addition, include a wireless-communication interface, which may enable it to communicate wirelessly with one or more devices.

The processor 504 may comprise multiple (e.g., parallel) processors, such as a general purpose microprocessor and/or a discrete digital signal processor. The data storage 506 may take various forms, in one or more parts, such as a non-volatile storage block and/or a removable storage medium. The data storage 506 may store program instructions 510, server data 512, communication protocols 514, and device management logic 516. The program instructions 510 may be executable by the processor 504 to carry out various server functions described herein. The server data 512 may include any type of data related to the server's functions, such as the configuration data mentioned above, and/or any other data.

The communication protocols 514 may be useful to receive data from and send data to one or more network entities, and may include any protocols suited to carrying out the functions described herein, including any proprietary protocols and/or any other protocols. Compatible protocols may be stored in entities in communication with server 106. The device management logic 516 may be used to manage aspects such as memory and file management.

### 3. Example Operation

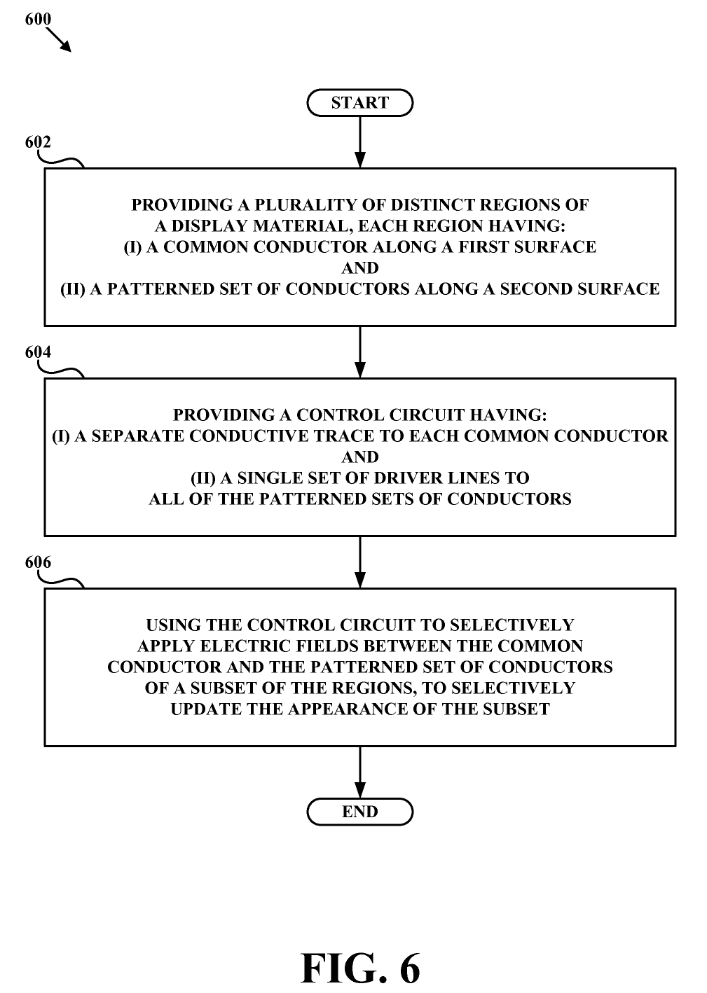

FIG. 6 depicts a method 600, in accordance with examples of embodiments. Note that this description of method 600 includes various terms and elements that have been described more fully above, and thus are used here without excessive description. Turning to FIG. 6, at step 602, a plurality of distinct regions of a display material is provided. Each region has a respective distinct common conductor positioned along a first surface of the region, such as a top surface (closest to a viewer). And the common conductors are preferably transparent, to permit viewing the display material through them. Each region also has a respective patterned set of conductors positioned along a second surface of the region, such as a bottom surface (furthest from a viewer) substantially opposite the first/top surface. Note that, instead of or in addition to the common conductors, the patterned sets of conductors may be transparent.

Each region of the display material includes a plurality of microcups, each having a first side and a second side, where the second side is substantially opposite the first side. The microcups are adjacent to one another in the display material, such that their collective first sides and their collective second sides respectively form the first and second surfaces referenced in the previous paragraph. The appearance of each respective microcup is responsive to application of an electric field between that microcup's first and second sides.

Each patterned set of conductors includes one or more individual conductors, each of which is aligned with one or more microcups of the display material. Furthermore, application of a voltage between (i) the common conductor of a given region and (ii) a subset of the individual conductors of the patterned set of the given region applies an electric field across the subset of microcups of the given region that are aligned with the subset of individual conductors—so as to update the state of those microcups to appear, for example, black or white. Note that each individual conductor may be aligned with exactly one microcup.

At step 604, a control circuit is provided, having a separate conductive trace connected to each respective common conductor, such that the control circuit can selectively apply known voltages (such as ground) to the common conductors of the various regions. The control circuit also has a single set of driver lines connected to all of the patterned sets of conductors, such that any sets of signals sent to any of the patterned sets are received by all of the patterned sets.

Furthermore, each of the patterned sets has a particular number of individual conductors, arranged in a standard pattern. And the single set of driver lines includes that same number of driver lines, each one connected to a respective corresponding set of individual conductors across all of the patterned sets. So, for example, one driver line could connect the control circuit to the upper-left-most individual conductor in each region, while another driver line could connect the control circuit to the lower-right-most individual conductor in each region, and so on.

At step 606, the control circuit is used to selectively apply electric fields between the common conductor and the patterned set of conductors of a subset of the regions, to selectively update the appearance of that subset of the regions. The subset of regions preferably consists of exactly one region, and the updating of that region's appearance may take the form of writing a name such as “Joe” to that region. As explained above, by writing the desired text to the patterned sets of conductors of all of the regions, but only setting to ground (or another known voltage) the common conductor of the region to which the control circuit wants to write, the control circuit can efficiently update only the desired region with, among other benefits, a reduced number of needed IC output lines to the overall multi-region display.

### 4. Conclusion

Various examples of embodiments have been described above. Those skilled in the art will understand, however, that changes and modifications may be made to those examples without departing from the scope of the claims.

1. A method comprising:
providing a plurality of distinct regions of a display material, wherein each region has a respective distinct common conductor positioned along a first surface of the region, wherein each region further has a respective patterned set of conductors positioned along a second surface of the region, wherein the second surface is substantially opposite the first surface;
providing a control circuit comprising a separate conductive trace connected to each respective common conductor, such that the control circuit can selectively apply known voltages to the common conductors of the various regions, wherein the control circuit further comprises a single set of driver lines connected to all of the patterned sets of conductors, such that any sets of signals sent to any of the patterned sets are received by all of the patterned sets; and
using the control circuit to selectively apply electric fields between the common conductor and the patterned set of conductors of a subset of the regions, so as to selectively update an appearance of the subset of the regions.

2. The method of claim 1, wherein the display material is flexible.

3. The method of claim 1, wherein at least one of (i) the common conductors and (ii) the patterned sets of conductors are transparent, permitting viewing of the appearances of the regions through the transparent conductors.

4. The method of claim 1, wherein each region comprises a plurality of microcups, wherein each microcup comprises a first side and a second side, wherein the second side is substantially opposite the first side, wherein the microcups are positioned adjacent to one another such that their collective first sides form the first surface and their collective second sides form the second surface, wherein an appearance of each respective microcup is responsive to application of an electric field between that microcup's first and second sides.

5. The method of claim 4, wherein each patterned set of conductors comprises one or more individual conductors, wherein each individual conductor is aligned with at least one microcup, wherein application of a voltage between (i) the common conductor of a given region and (ii) a subset of the individual conductors of the patterned set of the given region applies an electric field across a subset of the microcups of the region, wherein the subset of microcups consists of those microcups aligned with the subset of individual conductors.

6. The method of claim 5, wherein each individual conductor is aligned with exactly one microcup.

7. The method of claim 5, wherein each of the patterned sets has a first number of individual conductors arranged in a standard pattern, wherein the single set of driver lines comprises the first number of driver lines, each connected to a respective corresponding set of individual conductors across all of the patterned sets.

8. The method of claim 1, further comprising associating each region with a respective input mechanism of a packet-based telephony device.

9. The method of claim 8, wherein each respective input mechanism comprises a button, the method further comprising associating each button with at least one of a telephone line, a direct-dial function, a do-not-disturb function, and a voice-message function.

10. The method of claim 1, wherein the subset of the regions consists of one region.

11. The method of claim 1, wherein each region corresponds to multiple writable characters of text.

12. The method of claim 1, wherein each region corresponds to a single writable character of text.

13. A system comprising:
a plurality of distinct regions of a display material, wherein each region has a respective distinct common conductor positioned along a first surface of the region, wherein each region further has a respective patterned set of conductors positioned along a second surface of the region, wherein the second surface is substantially opposite the first surface; and
a control circuit comprising a separate conductive trace connected to each respective common conductor, such that the control circuit can selectively apply known voltages to the common conductors of the various regions, wherein the control circuit further comprises a single set of driver lines connected to all of the patterned sets of conductors, such that any sets of signals sent to any of the patterned sets are received by all of the patterned sets,
wherein the control circuit is operable to selectively apply electric fields between the common conductor and the patterned set of conductors of a subset of the regions, so as to selectively update an appearance of the subset of the regions.

14. The system of claim 13, wherein at least one of (i) the common conductors and (ii) the patterned sets of conductors are transparent, permitting viewing of the appearances of the regions through the transparent conductors.

15. The system of claim 13, wherein each region comprises a plurality of microcups, wherein each microcup comprises a first side and a second side, wherein the second side is substantially opposite the first side, wherein the microcups are positioned adjacent to one another such that their collective first sides form the first surface and their collective second sides form the second surface, wherein an appearance of each respective microcup is responsive to application of an electric field between that microcup's first and second sides.

16. The system of claim 15, wherein each patterned set of conductors comprises one or more individual conductors, wherein each individual conductor is aligned with at least one microcup, wherein application of a voltage between (i) the common conductor of a given region and (ii) a subset of the individual conductors of the patterned set of the given region applies an electric field across a subset of the microcups of the region, wherein the subset of microcups consists of those microcups aligned with the subset of individual conductors.

17. The system of claim 16, wherein each individual conductor is aligned with exactly one microcup.

18. The system of claim 16, wherein each of the patterned sets has a first number of individual conductors arranged in a standard pattern, wherein the single set of driver lines comprises the first number of driver lines, each connected to a respective corresponding set of individual conductors across all of the patterned sets.

19. The system of claim 13, wherein each region is associated with a respective input mechanism of a packet-based telephony device.

20. The system of claim 19, wherein each respective input mechanism comprises a button, and wherein each button is associated with at least one of a telephone line, a direct-dial function, a do-not-disturb function, and a voice-message function.

21. The system of claim 13, wherein the subset of the regions consists of one region.

22. The system of claim 13, wherein each region corresponds to multiple writable characters of text.

23. The system of claim 13, wherein each region corresponds to a single writable character of text.

24. A multi-region display comprising:
a patterned-conductor layer comprising a first number of patterned sets of conductors, wherein each patterned set corresponds to a respective region of the display, wherein each patterned set comprises a second number of individual conductors arranged in a standard pattern;
a microcup layer overlaying the patterned-conductor layer, wherein the microcup layer comprises a plurality of microcups, wherein each microcup comprises a first side and a second side, wherein the second side is substantially opposite the first side, wherein an appearance of each respective microcup is responsive to application of an electric field between that microcup's first and second sides, wherein the microcups are positioned adjacent to one another such that their collective first sides form a first surface of the microcup layer and their collective second sides form a second surface of the microcup layer, wherein the first surface overlays the patterned-conductor layer such that each individual conductor of each patterned set is aligned with one or more microcups of the microcup layer;
a common-conductor layer overlaying the second surface of the microcup layer, wherein the common-conductor layer comprises the first number of distinct common conductors, wherein each respective common conductor overlays the microcups that are aligned with a respective patterned set of conductors of the patterned-conductor layer, such that each respective common conductor corresponds to the same region of the display to which the respective patterned set of conductors with which that common conductor is aligned corresponds; and
a control circuit comprising (i) the first number of conductive traces, each connected to a respective common conductor and (ii) the second number of driver lines, each connected to a respective corresponding set of individual conductors across all of the patterned sets.

25. The multi-region display of claim 24, wherein the control circuit is operable to selectively update an appearance of a subset of the regions to display a particular pattern by (i) applying a known voltage to the conductive traces that are connected to the common conductors that correspond to the subset of regions and (ii) sending a particular set of signals along the driver lines to all of the patterned sets of conductors, wherein the particular set of signals corresponds to the particular pattern to be displayed on the subset of regions.

26. The multi-region display of claim 25, wherein the known voltage and the particular set of signals cooperate to apply an electric field between (i) the common conductors that correspond to the subset of regions and (ii) one or more of the individual conductors of the one or more patterned sets that correspond to the subset of regions, wherein an electric field is applied across the one or more microcups aligned with the one or more individual conductors of the one or more patterned sets that correspond to the subset of regions.

27. The multi-region display of claim 24, further comprising at least one of (i) a first non-conductive transparent layer overlaying the common-conductor layer opposite the microcup layer and (ii) a second non-conductive transparent layer overlaying the patterned-conductor layer opposite the microcup layer, such that the multi-region display is viewable by a user through at least one of the first and second non-conductive transparent layers.

28. The multi-region display of claim 24, wherein each region corresponds to multiple writable characters of text.

29. The multi-region display of claim 24, wherein each region corresponds to a single writable character of text.
